(19) United States
(12) Patent Application Publication
(10) Pub. No.: US 2006/0049045 A1
(43) Pub. Date: Mar. 9, 2006

(54) Three electrodes system cell for evaluation of performance of molten carbonate fuel cell

(75) Inventors: Jonghee Han, Seoul (KR); Seong Ahn Hong, Seoul (KR); Tae Hoon Lim, Seoul (KR); Suk-Woo Nam, Seoul (KR); In Hwan Oh, Seoul (KR); Sung Pil Yoon, Seoul (KR); Heung Yong Ha, Seoul (KR); EunAe Cho, Seoul (KR); Jaeyoung Lee, Incheon (KR); Bo Hyun Ryu, Seoul (KR)

Correspondence Address: MERCHANT & GOULD PC, P.O. BOX 2903, MINNEAPOLIS, MN, 55402-0903, US

(73) Assignee: Korea Institute of Science and Technology, Seoul (KR)

(21) Appl. No.: 11/011,590

(22) Filed: Dec. 13, 2004

(30) Foreign Application Priority Data
Sep. 3, 2004 (KR) 10-2004-70332

(51) Int. Cl. G01N 27/26; H01M 8/04

(52) U.S. Cl. 204/400; 429/35

(57) ABSTRACT

Disclosed is a three electrodes system cell for evaluation of performance of a molten carbonate fuel cell. A lower part of the reference electrode is fixed to a wet seal part of the single cell without penetrating a current collector plate and an electrode of the single cell. Preferably, the reference electrode comprises cured matrix slurry and powders of electrolyte stacked on the matrix slurry in the lower part thereof. Preferably, a diameter of an electrolyte-interchanging hole formed in a bottom of the lower part of the reference electrode is 1ψ. Preferably, an outer diameter of an alumina tube in the reference electrode is 6ψ. According to a three electrodes system cell for evaluation of performance of a molten carbonate fuel cell of the invention, it is possible to separately evaluate the performance of each electrode which cannot be evaluated by the prior method of evaluating the performance of the single cell. Particularly, contrary to the prior art, it is possible to prevent a crack of the matrix due to a physical shock and a heat shock resulting from the outflow and inflow of the supply gas, to reduce the gas leakage resulting from a decrease of adhesive strength between the matrix and the alumina tube and a heat shock due to the gas leakage, to improve the problem of electrolyte depletion and to reduce the physical defects resulting from a size of the reference electrode. Accordingly, it is possible to clearly measure the variation of the performance of each electrode while reducing the physical errors to the highest degree, to provide an exact criterion regarding the factor influencing on the variation of performance of the single cell when evaluating the performance of the single cell having 100 cm² of large area, and to directly evaluate the performance of the molten carbonate fuel cell.

### BACKGROUND OF THE INVENTION

1. Field of the Invention

The present invention relates to an improved three electrodes system cell for evaluation of performance of a molten carbonate fuel cell, particularly to an improved three electrodes system cell for evaluation of performance of a molten carbonate fuel cell capable of evaluating deterioration behaviors of each of factors, which influence on the long-time performance of the molten carbonate fuel cell, as time goes by.

2. Description of the Related Art

Since the molten carbonate fuel cell (MCFC) is operated at high temperature (for example, 650° C.), it has many advantages as well as merits provided by other fuel cells.

That is, since the MCFC can use high-quality of high temperature exhaust gas, it can be applied to a cogeneration system. In addition, since the MCFC can be operated under pressure, it can be also applied to a combined generation system connected with a gas turbine.

Accordingly, efforts of developing and commercializing the molten carbonate fuel cell have been continuously made.

However, a long time operation should be possible to commercialize the molten carbonate fuel cell. Further, a problem of lowering of performance should be settled for the long time operation.

Main factors causing the lowering of performance of the molten carbonate fuel cell are polarization of cathode and anode, cracking of the matrix and the electrolyte depletion.

Since these factors cause the lowering of performance of the cell, i.e., voltage loss, it is important to correctly analyze the voltage loss for a realization of a long time operation of the molten carbonate fuel cell.

Accordingly, the following methods have been suggested to evaluate the deterioration phenomena of the factors and to analyze the voltage loss.

For example, there has been known a single cell evaluation method.

In this method, a cell consists of a cathode, an anode and a matrix. Further, a cell frame made of STS316L is used. The cathode has 100 cm² of an area, the anode has 120 cm² of an area and an evaluation of performance of the cell is carried out as time goes by.

However, according to the method, there is a problem that it is impossible to separately evaluate the effects of each of factors. <Developments of Molten Carbonate Fuel Cell Stack having High Performance and High Reliability, Final Report, 2001, 1>

Further, there is a method using a three electrodes system cell. In this method, a third reference electrode that has no effect of polarization and is stable is mounted to a cell. It is then measured a potential difference with other electrode, and thus the polarization of each electrode is analyzed in-situ.

Among the methods using the three electrodes system cell, there is a method using a three electrodes system cell having 100 cm² of an electrode area.

FIG. 1 is a schematic view showing a structure of a three electrodes system cell having 100 cm² of an electrode area according to the prior art.

As shown in FIG. 1, a reference electrode comprises an alumina tube 80 surrounding and supporting a gold wire 90. The alumina tube 80 of the reference electrode is surrounded and supported by a stainless steel tube 70.

In addition, the alumina tube 80 of the reference electrode is filled with matrix and electrolyte in a lower part thereof. Also, the alumina tube is double tube-shaped at its upper part to be connected to an inlet 60 and an outlet 61 of a reference gas. Further, for example, 0.33 atm of O₂ and 0.67 atm of CO₂ are supplied.

A single cell comprises a current collector 40 intervening the matrix and the electrolyte 30 between the collector, cathode 10 and anode 20 formed on the current collector 400. In addition, the single cell comprises cathode gas inlet 11 and outlet 12, and an anode gas inlet 21 and outlet 21 at the periphery thereof and is supported by a cell frame.

For mounting the reference electrode, the cell frame in the cathode 10 side of the single cell is perforated, and then the stainless steel tube 70 is welded on the perforation.

Additionally, the current collector 40 and the cathode 10 of the single cell are also perforated so that the reference electrode is closely contacted with the electrolyte and the matrix 30 of the single cell, and then the alumina tube 80 having the gold wire 90 is fixed to a reference electrode mounting part 35 formed.

A salt bridge is formed in the lower part of the alumina tube 80 in which the gold wire 90 is contacted to the electrolyte and the matrix (30). At the same time, green sheets of electrolyte and matrix are inserted to the part in order to prevent the mixing of gases.

However, in the above method, since the reference electrode penetrates the current collector and the cathode of the single cell, there is voltage swings due to a discharge of the supply gas. Accordingly, it is impossible to evaluate an exact degree of polarization of an electrode.

Meanwhile, there is also a method using a three electrodes system cell having 3 cm² of an electrode area. In this method, areas of the cathode and the anode are 3 cm², and the cell frame is made of alumina.

However, this method neither can be used to evaluate the long time performance due to the electrolyte depletion. Instead, the use of the method is limited to an electrochemistry experiment for evaluating the polarization phenomena of the electrodes. <C. Y. Yuh, J. R. Selman, The Polarization of Molten Carbonate Fuel Cell Electrodes, J. Electrochem. 138(1991) 3649>

### SUMMARY OF THE INVENTION

Accordingly, the present invention has been made to solve the above-mentioned problems occurring in the prior art.

The object of the present invention is to provide an improved three electrodes system cell for evaluation of performance of a molten carbonate fuel cell, capable of separately evaluating a performance of each electrode which cannot have been evaluated by the prior method of evaluating a performance of a single cell.

The second aspect of the object of the invention is to provide an improved three electrodes system cell for evaluation of performance of a molten carbonate fuel cell, capable of preventing a crack of matrix due to a physical shock and a heat shock resulting from outflow and inflow of a supply gas, by changing a mounting position of a reference electrode, contrary to the prior three electrodes system cell.

The third aspect of the object of the invention is to provide an improved three electrodes system cell for evaluation of performance of a molten carbonate fuel cell, capable of reducing gas leakage resulting from a decrease of adhesive strength between a matrix and an alumina tube and a heat shock due to the gas leakage and improving a problem of electrolyte depletion, by improving the construction of a lower part of a reference electrode, contrary to the prior three electrodes system cell.

The fourth aspect of the object of the invention is to provide an improved three electrodes system cell for evaluation of performance of a molten carbonate fuel cell, capable of reducing physical defects resulting from a size of a conventional reference electrode, contrary to the prior three electrodes system cell.

In order to accomplish the above object, there is provided an improved three electrodes system cell for evaluation of performance of a molten carbonate fuel cell comprising a single cell and a reference electrode, wherein a lower part of the reference electrode is fixed to a wet seal part of the single cell without penetrating a current collector and an electrode of the single cell.

In the three electrodes system cell according to the present invention, the reference electrode comprises cured matrix slurry and powders of electrolyte stacked on the matrix slurry in the lower part of the reference electrode.

In the three electrodes system cell according to the present invention, a diameter of an electrolyte-interchanging hole formed in a bottom of the lower part of the reference electrode is 1ψ.

In the three electrodes system cell according to the present invention, an outer diameter of an alumina tube in the reference electrode is 6ψ.

### BRIEF DESCRIPTION OF THE DRAWINGS

FIG. 1 is a schematic view showing a structure of a three electrodes system cell having 100 cm² of an electrode area according to the prior art;

FIG. 2a is a schematic view showing a structure of a three electrodes system cell according to an embodiment of the invention;

FIG. 2b is a schematic view showing a lower part structure of the reference electrode of a three electrodes system cell according to an embodiment of the invention;

FIG. 2c is an enlarged schematic view showing a bottom of a lower part of the reference electrode of a three electrodes system cell according to an embodiment of the invention;

FIG. 3 is a graph showing a variation of performance of a cathode as time goes by under 150 mA/cm² of load when using the three electrodes system cell according to an embodiment of the invention;

FIG. 4 is a graph showing a variation of performance of an anode as time goes by under 150 mA/cm² of load when using the three electrodes system cell according to an embodiment of the invention; and

FIG. 5 is a graph showing a variation of performance of the total cell as time goes by under 150 mA/cm² of load when using the three electrodes system cell according to an embodiment of the invention.

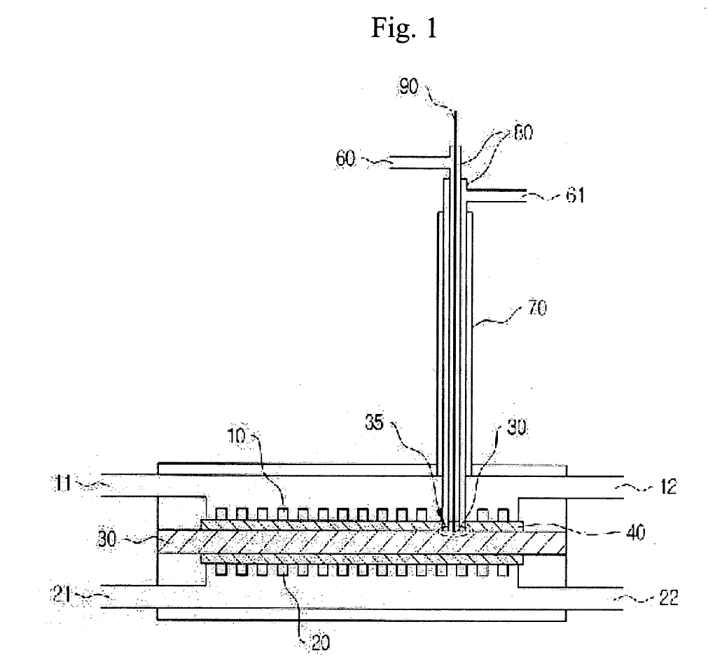

### DETAILED DESCRIPTION OF THE INVENTION

Hereinafter, preferred embodiments of the present invention will be described with reference to the accompanying drawings. In the following description of the present invention, a detailed description of known functions and configurations incorporated herein will be omitted when it may make the subject matter of the present invention rather unclear.

In the following context, a lower part of a reference electrode is a part of the reference electrode at which the reference electrode and matrix meet, and at which outflows and inflows of electrolyte in the reference electrode and ions in the matrix occur.

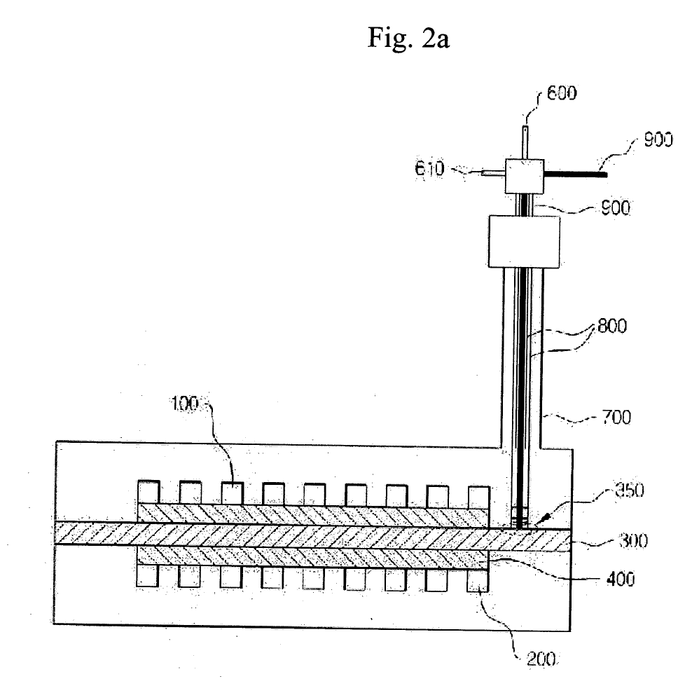

FIG. 2a is a schematic view showing a structure of a three electrodes system cell according to an embodiment of the invention.

As shown in FIG. 2a, a reference electrode comprises an alumina tube 800 surrounding and supporting a gold wire 900. The alumina tube 800 of the reference electrode is surrounded and supported by a stainless steel tube 700.

In addition, the alumina tube 800 of the reference electrode is connected to an inlet 600 and an outlet 610 of a reference gas, and double tube-shaped in order to correspond to the outflow and inflow of the gas.

Herein, a size of the reference electrode is greatly decreased by reducing a diameter of the alimina tube 800 (i.e., an outer diameter of the double tube). That is, contrary to the 9ψ of diameter in the prior art, it is possible to reduce the diameter to 6ψ. Therefore, it can become possible to reduce physical defects resulting from a size of the conventional reference electrode.

A single cell is a commercial single cell, comprises a current collector 400 intervening a matrix and electrolyte 300 there-between, cathode 100 and anode 200 formed on the current collector 400, and is supported by a cell frame. In addition, the single cell comprises cathode gas inlet and outlet, and anode gas inlet and outlet (they are not specifically shown in FIG. 2a).

For mounting the reference electrode, the cell frame in the cathode 100 side of the single cell is perforated and the stainless steel tube 700 is welded on the perforation. Herein, the position of the perforation is adjusted so that the alumina tube 800 in the stainless steel tube 700 is mounted just to a wet seal part 350 of the single cell without penetrating the current collector 400 and the cathode 100 of the single cell.

The alumina tube 800 is closely contacted with the electrolyte and the matrix 300 of the single cell at the wet seal part 350 and does not penetrate the current collector 400 and the cathode 100 of the single cell, as described above.

Therefore, since the reference electrode does not penetrate the current collector 400 and the cathode 100, it is possible to prevent a crack of the matrix due to a physical shock or a heat shock resulting from the outflow and inflow of supply gas.

FIG. 2b is a schematic view showing a lower part structure of the reference electrode of a three electrodes system cell according to an embodiment of the invention.

As shown in FIG. 2b, in the lower part of the alumina tube 800 (the gold wire 900 is contacted to the electrolyte and the matrix 300 at the lower part), matrix slurry 310 is directly inputted and cured in the alumina tube 800 and then powders of electrolyte 320 are stacked on the slurry, and electrolyte sheet and matrix sheet are not used as the prior art.

Accordingly, it is possible to solve the problem of the heat shock due to gas leakage resulting from a decrease of adhesive strength between the matrix and the alumina tube.

FIG. 2c is an enlarged schematic view showing a bottom of the lower part of the reference electrode of a three electrodes system cell according to an embodiment of the invention.

As shown in FIG. 2c, the electrolyte is interchanged only through a hole 910 having 1ψ of a diameter which is formed in a center of a bottom of the cured matrix slurry 310 in the alumina tube 800. Thereby, it is possible to improve the problem of electrolyte depletion in the reference electrode.

<Experiment>

In this experiment, it was observed variations of performances of each electrode and the total cell according as time went by under 150 mA/cm² of load, using the three electrodes system cell having the reference electrode mounted thereto according to an embodiment of the invention as described above.

In this experiment, the cathode consisted of pure Ni having 80% of porosity, the anode consisted of Ni-10 wt % Cr having 60% of porosity, the matrix was LiAlO₂ and the electrolyte was Li₂CO₃/K₂CO₃ (=70/30).

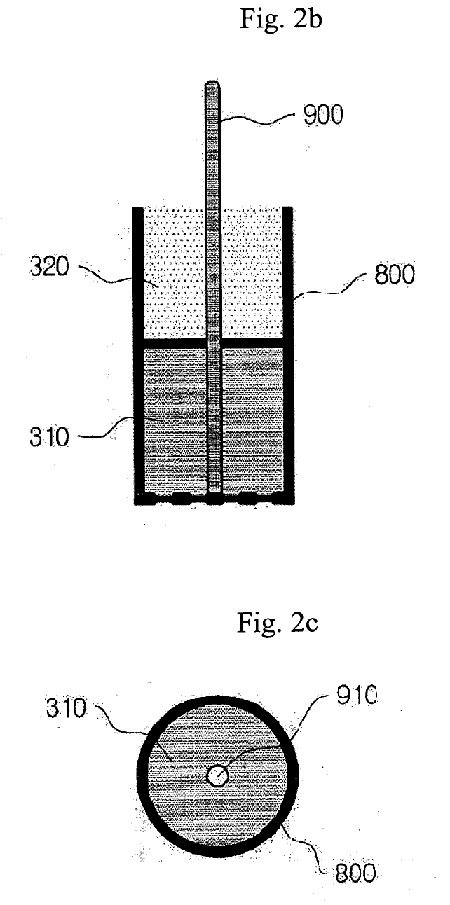

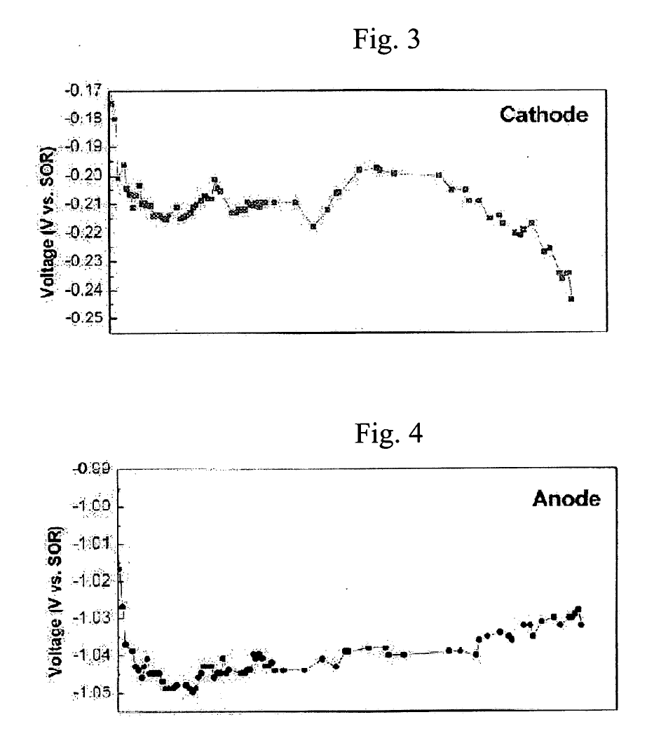

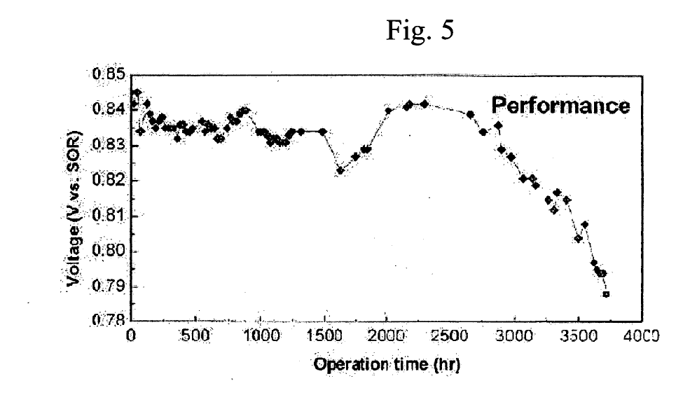

FIGS. 3 to 5 are graphs showing variations of performances of each electrode and the total cell as time went by under 150 mA/cm² of load, using the three electrodes system cell according to an embodiment of the invention. FIG. 3 is a graph showing a variation of performance of the cathode, FIG. 4 is a graph showing a variation of performance of the anode and FIG. 5 is a graph showing a variation of performance of the total cell.

As shown in FIGS. 3 to 5, it was possible to clearly evaluate polarized state of each electrode according as time went by, using the reference electrode.

In particular, it came to our knowledge that over-voltage of the cathode was greater than that of the anode, when comparing magnitudes of over-voltage of each electrode under 150 mA/cm² of load. This shows that the polarization of the cathode has a greater influence on the lowering of the performance of the cell than the anode.

Like this, when using the three electrodes system cell according to the invention, it is possible to clearly evaluate variation of performance of each electrode because a physical error can be reduced to the highest degree.

This provides an exact criterion capable of judging which factor has a greatest influence on the variation of performance of the single cell, when evaluating the performance of the single cell having 100 cm² of large area.

In addition, when developing new constituents of the cell, the three electrodes system cell according to the invention is very useful for evaluating characteristics of the newly developed constituents because the three electrodes system cell can directly measure phenomena actually occurring in the molten carbonate fuel cell.

As described above, according to the improved three electrodes system cell for evaluating the performance of the molten carbonate fuel cell of the invention, it is possible to separately evaluate the performance of each electrode which cannot have been evaluated by the prior method of evaluating the performance of the single cell.

Particularly, contrary to the prior art, it is possible to prevent a crack of the matrix due to a physical shock and a heat shock resulting from the outflow and inflow of the supply gas, to reduce the gas leakage resulting from a decrease of adhesive strength between the matrix and the alumina tube and a heat shock due to the gas leakage, to improve the problem of electrolyte depletion and to reduce the physical defects resulting from a size of the conventional reference electrode.

Accordingly, it is possible to clearly measure the variation of the performance of each electrode while reducing the physical errors to the highest degree, to provide an exact criterion regarding the factor influencing on the variation of performance of the single cell when evaluating the performance of the single cell having 100 cm² of large area, and to directly evaluate the performance of the molten carbonate fuel cell.

What is claimed is:

1. A three electrodes system cell for evaluation of performance of a molten carbonate fuel cell comprising a single cell and a reference electrode, wherein a lower part of the reference electrode is fixed to a wet seal part of the single cell without penetrating a current collector plate and an electrode of the single cell.

2. The three electrodes system cell according to claim 1, wherein the reference electrode comprises cured matrix slurry and powders of electrolyte stacked on the matrix slurry in the lower part of the reference electrode.

3. The three electrodes system cell according to claim 2, wherein a diameter of an electrolyte-interchanging hole formed in a bottom of the lower part of the reference electrode is 1ψ

4. The three electrodes system cell according to claim 1, wherein an outer diameter of an alumina tube in the reference electrode is 6ψ.
